(19) United States
(12) Patent Application Publication
(10) Pub. No.: US 2024/0174118 A1
(43) Pub. Date: May 30, 2024

(54) SERVER, SYSTEM, AND MANAGEMENT METHOD

(71) Applicant: TOYOTA JIDOSHA KABUSHIKI KAISHA, Toyota-shi (JP)

(72) Inventor: Akinori MORISHIMA, Naka-gun (JP)

(73) Assignee: TOYOTA JIDOSHA KABUSHIKI KAISHA, Toyota-shi (JP)

(21) Appl. No.: 18/368,716

(22) Filed: Sep. 15, 2023

(30) Foreign Application Priority Data
Nov. 28, 2022 (JP) 2022-189194

(51) Int. Cl. B60L 53/68; B60L 53/66; B60L 53/67; G06Q 10/02

(52) U.S. Cl. CPC B60L 53/68; B60L 53/665; B60L 53/67; G06Q 10/02

(57) ABSTRACT

A server includes a communication unit configured to acquire information on a power supply and demand balancing request, and one or more processors configured to control power control in a reservation slot in which a reservation is made for the power control by a user of an electrified vehicle. The processors are configured to execute control to check, with the user during a period from a start of the power control in the reservation slot to a time immediately after an end of the power control, whether the power control responding to the power supply and demand balancing request is executable after the reservation slot.

### CROSS-REFERENCE TO RELATED APPLICATION

This application claims priority to Japanese Patent Application No. 2022-189194 filed on Nov. 28, 2022, incorporated herein by reference in its entirety.

### BACKGROUND

### 1. Technical Field

The present disclosure relates to a server, a system, and a management method.

### 2. Description of Related Art

WO2013/137071 discloses a system that charges an electrified vehicle based on a reservation for use of a charger.

### SUMMARY

In the system disclosed in WO2013/137071, it is difficult to respond to a request to balance power supply and demand in a predetermined power system by using an electrified vehicle after a reservation slot for charging the electrified vehicle has ended. Therefore, there is a demand for a system that can easily respond to a power supply and demand balancing request in a predetermined power system.

The present disclosure provides a server, a system, and a management method that can easily respond to a power supply and demand balancing request in a predetermined power system.

A server according to a first aspect of the present disclosure is a server configured to manage power control between a power controller and an electrified vehicle. The power control includes at least one of charging and discharging. The server includes a communication unit configured to acquire information on a power supply and demand balancing request for balancing a power supply and demand status in a predetermined power system, and one or more processors configured to control the power control in a reservation slot in which a reservation is made for the power control by a user of the electrified vehicle. The one or more processors are configured to execute control to check, with the user during a period from a start of the power control in the reservation slot to a time immediately after an end of the power control, whether the power control responding to the power supply and demand balancing request is executable after the reservation slot.

According to such a configuration, the user of the electrified vehicle can recognize that the power control is requested after the reservation slot. As a result, it is possible to easily increase the number of users who carry out the power control after the reservation slot. Thus, it is possible to easily respond to the power supply and demand balancing request in the predetermined power system. Since the check is made during the period from the start of the power control in the reservation slot to the time immediately after the end of the power control, the power control responding to the power supply and demand balancing request can be executed continuously with the power control in the reservation slot. Thus, the user of the electrified vehicle can more actively carry out the power control responding to the power supply and demand balancing request.

In the server according to the first aspect, the one or more processors may be configured to adjust a length of an execution period of the power control to be executed after the reservation slot based on predetermined information on electric power to be exchanged between the predetermined power system and the electrified vehicle by the power control after the reservation slot. According to such a configuration, it is possible to appropriately adjust the length of the period in which the power control is executed after the reservation slot based on the electric power to be exchanged between the predetermined power system and the electrified vehicle.

In the server according to the first aspect, the predetermined information may include information on an upper limit value or a lower limit value specified by the user about a state of charge (SOC) of the electrified vehicle. According to such a configuration, it is possible to appropriately adjust the length of the period in which the power control is executed after the reservation slot based on the upper limit value or the lower limit value of the SOC specified by the user.

In the server according to the first aspect, the predetermined information may include information on the power supply and demand status in the predetermined power system after the reservation slot. According to such a configuration, it is possible to appropriately adjust the length of the period in which the power control is executed after the reservation slot based on the power supply and demand status in the predetermined power system after the reservation slot.

In the server according to the first aspect, the predetermined information may include information on a permissible value of an amount of change in an SOC of the electrified vehicle by the power control after the reservation slot. The permissible value may be estimated by the one or more processors based on a change history of the SOC. According to such a configuration, it is possible to appropriately adjust the length of the period in which the power control is executed after the reservation slot based on the permissible value of the amount of change in the SOC by the power control after the reservation slot.

In the server according to the first aspect, the one or more processors may be configured to check availability of the power controller after the reservation slot before checking with the user whether the power control is executable after the reservation slot. According to such a configuration, it is possible to reduce the occurrence of a case where a plurality of reservations for the power controller overlaps after the reservation slot.

In the server according to the first aspect, the one or more processors may be configured to determine whether to check with the user whether the power control is executable after the reservation slot based on an SOC of the electrified vehicle after the power control in the reservation slot. According to such a configuration, it is possible to reduce the occurrence of a case where the power control is executed after the reservation slot with an insufficient SOC.

In the server according to the first aspect, the communication unit may be configured to acquire user stay information as to whether the user is expected to stay after the reservation slot at a predetermined commercial facility including the power controller. The one or more processors may be configured to determine whether to check with the user whether the power control is executable after the reservation slot by using the user stay information acquired by the communication unit. According to such a configuration, it is possible to reduce the occurrence of a case where the check as to whether the power control is executable is made when determination is made that it is inappropriate to execute the power control after the reservation slot based on the stay period of the electrified vehicle.

In the server according to the first aspect, the communication unit may be configured to acquire information on the power supply and demand balancing request in a power grid included in the predetermined power system. According to such a configuration, it is possible to easily respond to the power supply and demand balancing request in the power grid after the reservation slot.

In the server according to the first aspect, the one or more processors may be configured to execute control to notify the user that an execution period of the power control is to be extended when confirmation is made that the power control is executable after the reservation slot. According to such a configuration, the user can securely grasp that the execution period of the power control is to be extended after the reservation slot.

In the server according to the first aspect, the one or more processors may be configured to cause the electrified vehicle to execute the power control responding to the power supply and demand balancing request after the reservation slot when confirmation is made that the power control is executable after the reservation slot. According to such a configuration, it is possible to easily respond to the power supply and demand balancing request in the power grid by controlling the charging or discharging of the electrified vehicle.

A system according to a second aspect of the present disclosure includes a power controller configured to execute power control including at least one of charging and discharging, an electrified vehicle, and a server configured to manage the power control between the power controller and the electrified vehicle. The server is configured to acquire information on a power supply and demand balancing request for balancing a power supply and demand status in a predetermined power system, control the power control in a reservation slot in which a reservation is made for the power control by a user of the electrified vehicle, and execute control to check, with the user during a period from a start of the power control in the reservation slot to a time immediately after an end of the power control, whether the power control responding to the power supply and demand balancing request is executable after the reservation slot.

According to such a configuration, the control to check with the user whether the power control responding to the power supply and demand balancing request is executable after the reservation slot is executed during the power control in the reservation slot or at the end of the power control in the reservation slot. Thus, it is possible to provide the system that can easily respond to the power supply and demand balancing request in the predetermined power system.

A management method according to a third aspect of the present disclosure is a management method for managing power control between a power controller and an electrified vehicle. The power control includes at least one of charging and discharging. The management method includes acquiring information on a power supply and demand balancing request for balancing a power supply and demand status in a predetermined power system, controlling the power control in a reservation slot in which a reservation is made for the power control by a user of the electrified vehicle, and checking, with the user during a period from a start of the power control in the reservation slot to a time immediately after an end of the power control, whether the power control responding to the power supply and 10 demand balancing request is executable after the reservation slot.

According to such a configuration, the control to check with the user whether the power control responding to the power supply and demand balancing request is executable after the reservation slot is executed during the power control in the reservation slot or at the end of the power control in the reservation slot. Thus, it is possible to provide the management method that can easily respond to the power supply and demand balancing request in the predetermined power system.

According to the present disclosure, it is possible to easily respond to the power supply and demand balancing request in the predetermined power system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a system according to a first embodiment:

FIG. 2 shows sequence control of the system according to the first embodiment:

FIG. 3 shows an example of an electric vehicle supply equipment (EVSE) reservation schedule:

FIG. 4 shows the configuration of a system according to a second embodiment:

FIG. 5 shows sequence control of the system according to the second embodiment:

FIG. 6 shows the configuration of a system according to a third embodiment:

FIG. 7 shows sequence control of the system according to the third embodiment: and

FIG. 8 shows the configuration of a system according to a modification of the first to third embodiments.

### DETAILED DESCRIPTION OF EMBODIMENTS

### First Embodiment

Hereinafter, a first embodiment of the present disclosure will be described in detail with reference to the drawings. The same or corresponding parts are denoted by the same signs throughout the drawings, and description thereof will not be repeated.

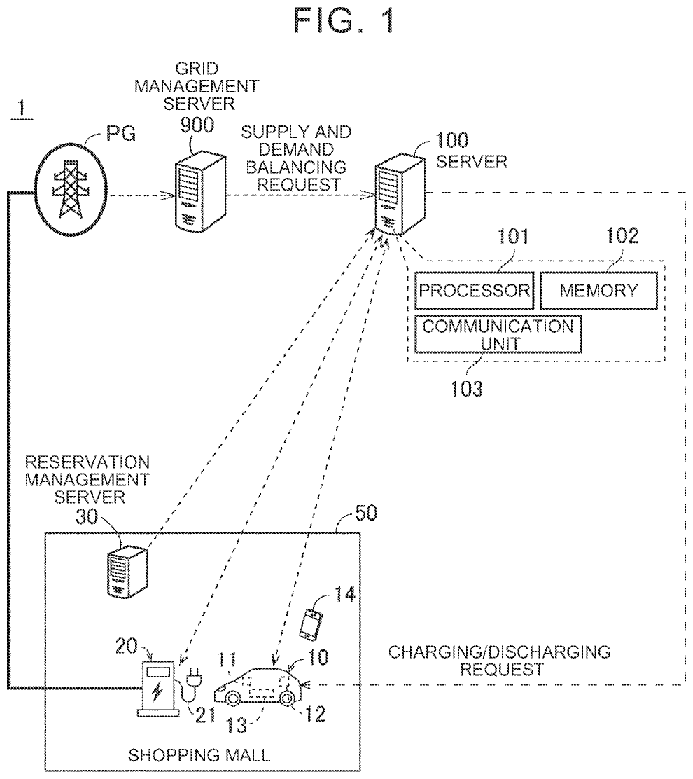

FIG. 1 shows the configuration of a system 1 according to the first embodiment. The system 1 includes a server 100, a grid management server 900, a power grid (PG), an electrified vehicle 10, an electric vehicle supply equipment (EVSE) unit 20, and a reservation management server 30.

The power grid PG is an electric power network constructed of power plants and power transmission and distribution facilities (neither of which is shown). In the present embodiment, an electric power company serves as both a power generation operator and a power transmission and distribution operator. The electric power company corresponds to a general power transmission and distribution operator, and maintains and manages the power grid PG. The electric power company is equivalent to a manager of the power grid PG.

The grid management server 900 manages power supply and demand on the power grid PG. The grid management server 900 belongs to the electric power company. The grid management server 900 transmits a request to balance the power demand amount on the power grid PG (supply and demand balancing request) to the server 100 based on power generation and consumption of each power balancing resource managed by the grid management server 900. Specifically, when the amount of power generation or consumption of the power balancing resource is expected to be larger than usual (or is currently large), the grid management server 900 transmits a request to the server 100 to increase or reduce the power demand amount than usual.

The server 100 is managed by an aggregator. The aggregator is an electric utility that provides an energy management service by bundling a plurality of power balancing resources in an area, a predetermined facility, or the like. The server 100 manages power control described later.

The server 100 requests the electrified vehicle 10 to execute “power control” as one way to increase or reduce the power demand amount on the power grid PG. The power control includes power feeding to the power grid PG (external power feeding) and charging from the power grid PG (external charging). The server 100 transmits a request signal for requesting the power control to, for example, the electrified vehicle 10 or a mobile terminal 14 of a user of the electrified vehicle 10. The electrified vehicle 10 may execute only one of the external power feeding and the external charging.

The power control is executed between the electrified vehicle 10 and the power grid PG via the EVSE unit 20. Examples of the electrified vehicle 10 include a plug-in hybrid electric vehicle (PHEV), a battery electric vehicle (BEV), and a fuel cell electric vehicle (FCEV).

The electrified vehicle 10 includes a car navigation system 11 and a communication device 12. The electrified vehicle 10 further includes a battery 13 that supplies electric power to electric devices such as the car navigation system 11 and the communication device 12. The communication device 12 may include a data communication module (DCM) or may include a communication interface (I/F) compatible with the fifth generation mobile communication system (5G).

The EVSE unit 20 means equipment for supplying electric power to vehicles. The electrified vehicle 10 is electrically connectable to the EVSE unit 20. For example, electric power can be exchanged between the EVSE unit 20 and the electrified vehicle 10 by connecting a charging cable 21 connected to the EVSE unit 20 to an inlet of the electrified vehicle 10.

The reservation management server 30 manages the reservation status of the power control of the electrified vehicle 10 (and other electrified vehicles) in the EVSE unit 20. Before using the EVSE unit 20, the user of the electrified vehicle 10 makes a reservation for the use of the EVSE unit 20 by designating a desired use time frame (reservation slot).

The EVSE unit 20 and the reservation management server 30 are provided in a shopping mall 50. The reservation management server 30 may be provided outside the shopping mall 50. The shopping mall 50 is an example of a “predetermined commercial facility” of the present disclosure.

The server 100 manages information on a plurality of registered electrified vehicles 10 (hereinafter also referred to as “vehicle information”), information on each registered user (hereinafter also referred to as “user information”), and information on the registered EVSE unit 20 (hereinafter also referred to as “EVSE information”). The user information, the vehicle information, and the EVSE information are distinguished by identification information (IDs) and stored in a memory 102 described later.

A user ID is identification information for identifying a user, and also serves as information for identifying the mobile terminal 14 carried by the user (terminal ID). The server 100 distinguishes and saves information received from the mobile terminal 14 by the user ID. The user information includes a communication address of the mobile terminal 14 carried by the user, and a vehicle ID of the electrified vehicle 10 belonging to the user.

The vehicle ID is identification information for identifying the electrified vehicle 10. The vehicle ID may be a license plate number or may be a vehicle identification number (VIN). The vehicle information includes an operation schedule of each electrified vehicle 10.

An EVSE-ID is identification information for identifying the EVSE unit 20. The EVSE information includes a communication address of each EVSE unit 20 and the state of the electrified vehicle 10 connected to the EVSE unit 20. The EVSE information also includes information indicating a combination of the electrified vehicle 10 and the EVSE unit 20 connected to each other (e.g., a combination of the EVSE-ID and the vehicle ID).

The server 100 includes a processor 101, the memory 102, and a communication unit 103.

The memory 102 stores, in addition to programs to be executed by the processor 101, information to be used in the programs (e.g., maps, mathematical formulas, and various parameters). The communication unit 103 includes one or more communication modules and various communication I/Fs. The processor 101 controls the communication unit 103. Specifically, the processor 101 communicates with the grid management server 900, the communication device 12 of the electrified vehicle 10 (or the mobile terminal 14), the EVSE unit 20, and the reservation management server 30 via the communication unit 103.

The communication unit 103 acquires information on the power control of the electrified vehicle 10. Specifically, the communication unit 103 acquires information such as charging/discharging amounts, charging/discharging periods, and time frames during which charging and discharging are executed between the electrified vehicle 10 and the EVSE unit 20 for which the power control is executed.

In the related-art system, the electrified vehicle 10 leaves the EVSE unit 20 after the charging reservation slot has ended. Therefore, it is difficult to respond to a request to balance power supply and demand, for example, in the power grid PG. Therefore, there is a demand for a system that can easily respond to a power supply and demand balancing request in a predetermined power system such as the power grid PG.

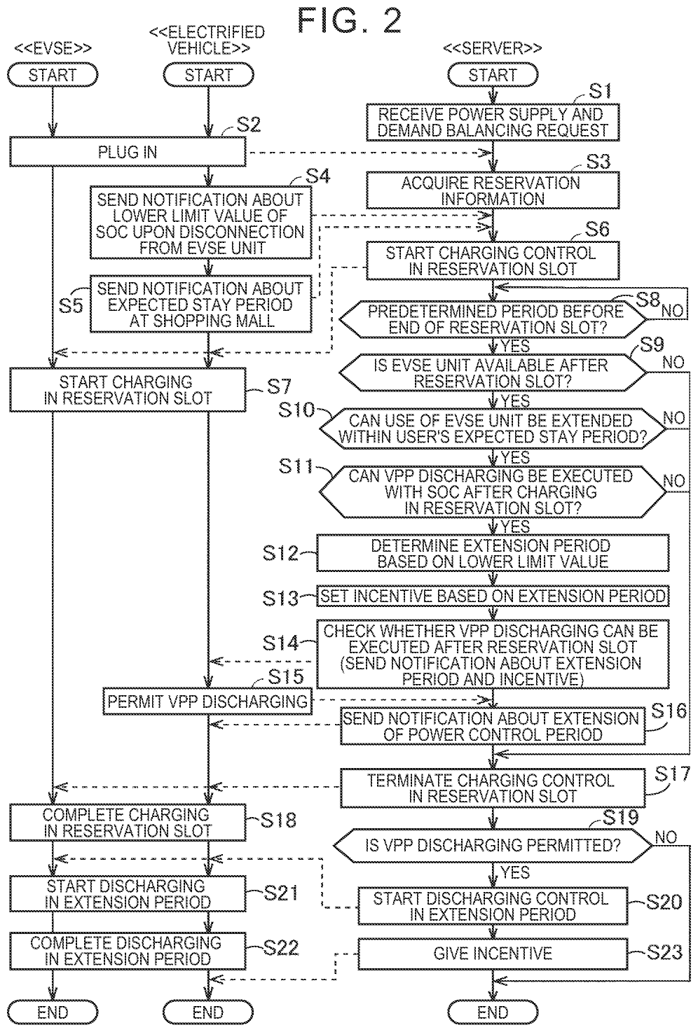

The processor 101 executes control to check with the user during charging in the reservation slot whether the power control responding to the power supply and demand balancing request can be executed after the reservation slot. Detailed control will be described with reference to a sequence diagram of FIG. 2.

### Management Method

In step S1, the server 100 receives a power supply and demand balancing request in the power grid PG from the grid management server 900 via the communication unit 103. The process of step S1 may be executed at predetermined intervals. In the first embodiment, the power supply and demand balancing request is a request for external power feeding (discharging) from the electrified vehicle 10. Hereinafter, the external power feeding may be referred to as “virtual power plant (VPP) discharging”.

In step S2, the electrified vehicle 10 is electrically connected to the EVSE unit 20. In other words, the electrified vehicle 10 is plugged into the EVSE unit 20 in step S2.

In step S3, the server 100 (communication unit 103) acquires reservation information of the electrified vehicle 10 for the EVSE unit 20 registered in the reservation management server 30 via the communication unit 103 based on information on the electrified vehicle 10 plugged into the EVSE unit 20.

In step S4, the user of the electrified vehicle 10 sends a notification about a lower limit value of a state of charge (SOC) of the battery 13 at the time of disconnection from the EVSE unit 20 via the communication device 12 or the mobile terminal 14. The lower limit value means a minimum value desired by the user about the remaining SOC at the time of disconnection between the EVSE unit 20 and the electrified vehicle 10.

In step S5, the user of the electrified vehicle 10 sends a notification about information on the user's expected stay period at the shopping mall 50 via the communication device 12 or the mobile terminal 14.

The server 100 may permit the user to continue the plugged-in state even after the charging in the reservation slot is completed as an incentive for the notifications in steps S4 and S5. The incentive may include, for example, a discount on the usage fee of the EVSE unit 20.

In step S6, the server 100 (processor 101) starts charging control on the electrified vehicle 10 in the reservation slot. Thus, charging is started between the electrified vehicle 10 and the EVSE unit 20 in step S7.

In step S8, the processor 101 determines whether the current time is a predetermined period (e.g., 5 minutes) before the end time of the reservation slot. When the current time is the predetermined period before the end time (Yes in S8), the process proceeds to step S9. When the current time is not the predetermined period before the end time (No in S8), the process of step S8 is repeated.

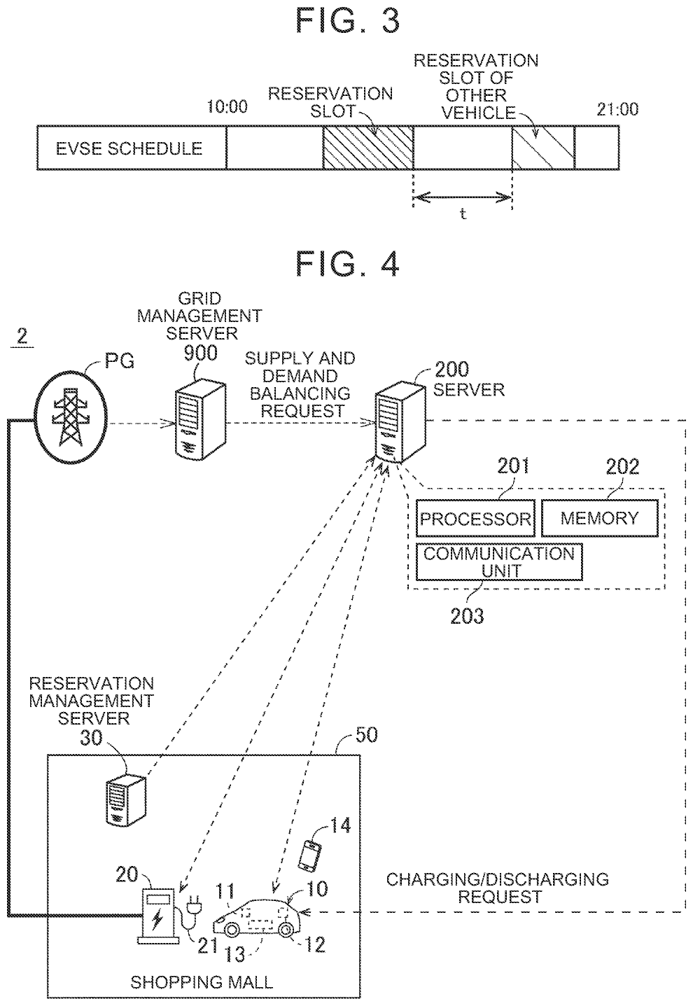

In step S9, the processor 101 checks with the reservation management server 30 whether the EVSE unit 20 is available after the reservation slot. When the EVSE unit 20 is available (Yes in S9), the process proceeds to step S10. When the EVSE unit 20 is not available (No in S9), the process proceeds to step S17. Assuming that the minimum period of the reservation slot of the EVSE unit 20 is, for example, 30 minutes, the processor 101 determines that the EVSE unit 20 is available when an available period t (see FIG. 3) of the EVSE unit 20 after the reservation slot is equal to or longer than 30 minutes. Determination may be made that the EVSE unit 20 is available when the EVSE unit 20 is available even for a short period after the reservation slot.

In step S10, the processor 101 determines whether the use of the EVSE unit 20 can be extended after the reservation slot based on the user's stay period acquired in the process of step S5. When the use of the EVSE unit 20 can be extended (Yes in S10), the process proceeds to step S11. When the use of the EVSE unit 20 cannot be extended (No in S10), the process proceeds to step S17. Assuming that the minimum period of the reservation slot of the EVSE unit 20 is, for example, 30 minutes, the processor 101 determines that the use of the EVSE unit 20 can be extended when the user is expected to stay at the shopping mall 50 for 30 minutes or longer after the reservation slot. Determination may be made that the use of the EVSE unit 20 can be extended when the user is expected to stay at the shopping mall 50 even for a short period after the reservation slot.

In step S11, the processor 101 determines whether VPP discharging responding to the request in step S1 can be executed after the reservation slot based on the SOC of the electrified vehicle 10 after the charging in the reservation slot. When the VPP discharging can be executed (Yes in S11), the process proceeds to step S12. When the VPP discharging cannot be executed (No in S11), the process proceeds to step S17. The processor 101 may calculate a predicted value of the SOC at the end of the reservation slot based on a charging rate in the reservation slot, and determine that the VPP discharging can be executed when the predicted value is equal to or larger than a predetermined threshold value (e.g., 80%). The predetermined threshold value may be calculated based on the lower limit value of the SOC acquired in the process of step S4.

Although the present embodiment illustrates the example in which the processes of steps S9 to S11 are executed, the present disclosure is not limited to this. The processes of steps S9 to S11 need not be executed. Any one of steps S9 to S11 may be executed. Any two of steps S9 to S11 may be executed.

In step S12, the processor 101 determines an extension period after the reservation slot based on the lower limit value of the SOC acquired in the process of step S4. The extension period is a period during which the VPP discharging by the user is requested. For example, the processor 101 calculates a difference between (the predicted value of) the SOC at the end time of the reservation slot and the lower limit value. Next, the processor 101 calculates a predicted period for the SOC to reach the lower limit value based on the difference and a discharging rate (rate of decrease in the SOC by discharging). The processor 101 determines the extension period based on the calculated predicted period. When the determined extension period overlaps the next reservation slot of the EVSE unit 20, the length of the extension period may be adjusted based on the start time of the next reservation slot.

In step S13, the processor 101 sets an incentive to be given to the user based on the length of the extension period determined in step S12. Examples of the incentive include a discount on the usage fee of the EVSE unit 20, a coupon that can be used in the shopping mall 50, and a discount on the usage fee of a parking lot of the shopping mall 50. The incentive may be changed depending on the amount of money used for shopping by the user during the stay at the shopping mall 50.

In step S14, the processor 101 executes control to check with the user via the communication unit 103 whether the VPP discharging requested in step S1 can be executed. Specifically, the processor 101 notifies the user about information on the extension period and the incentive determined in steps S12 and S13, thereby prompting the user to choose (reply) whether the VPP discharging can be executed.

In step S15, the user of the electrified vehicle 10 replies that the VPP discharging can be executed in response to the check from the server 100 in step S14.

In step S16, the processor 101 notifies the user via the communication unit 103 that the execution period of the power control will be extended. In other words, the processor 101 notifies the user that the extension period determined in step S12 will be provided after the reservation slot. The notification in step S16 may be executed by the reservation management server 30.

In step S17, the processor 101 terminates the charging control in the reservation slot started in step S6. In step S18, the charging between the electrified vehicle 10 and the EVSE unit 20 is completed in response to the process of step S17.

In step S19, the processor 101 determines whether the user permits the VPP discharging based on the reply in step S15. When the VPP discharging is permitted (Yes in S19), the process proceeds to step S20. When the VPP discharging is not permitted (No in S19), the process is terminated.

In step S20, the processor 101 causes the electrified vehicle 10 to execute the VPP discharging (start the VPP discharging) in response to the power supply and demand balancing request in step S1 during the extension period after the reservation slot.

In step S21, the VPP discharging between the electrified vehicle 10 and the EVSE unit 20 is started in response to the process of step S20. In step S22, the VPP discharging started in the process of step S21 is completed. In step S23, the processor 101 gives the incentive based on a record of the VPP discharging executed in steps S21 and S22.

As described above, in the first embodiment, the processor 101 executes the control to check with the user during the charging of the electrified vehicle 10 in the reservation slot whether the power control (VPP discharging) responding to the power supply and demand balancing request can be executed after the reservation slot. Thus, it is possible to increase the number of users who continue to use the EVSE units 20 for the VPP discharging after the reservation slots.

### Second Embodiment

Next, a second embodiment of the present disclosure will be described. In the second embodiment, the extension period is determined based on the power supply and demand status of the power grid unlike the first embodiment in which the extension period is determined based on the lower limit value specified by the user. The same components as those in the first embodiment are denoted by the same signs as those in the first embodiment, and description thereof will not be repeated.

FIG. 4 shows the configuration of a system 2 according to the second embodiment. The system 2 includes a server 200 instead of the server 100 of the system 1 of the first embodiment.

The server 200 includes a processor 201, a memory 202, and a communication unit 203. The processor 201 is an example of a “control unit” according to the present disclosure. The communication unit 203 is an example of a “first acquisition unit” and a “second acquisition unit” according to the present disclosure.

### Management Method

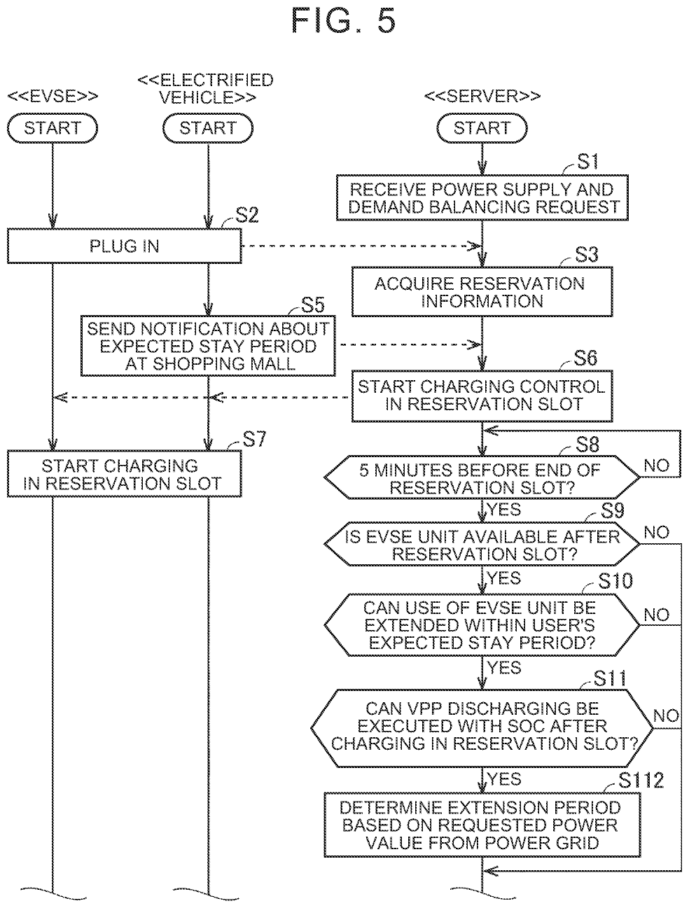

Next, a method for managing the power control by the system 2 will be described with reference to a sequence diagram of FIG. 5. Steps of the same processes as those of the first embodiment are denoted by the same signs, and description thereof will not be repeated.

As shown in FIG. 5, the process of step S4 in the first embodiment is not executed in the second embodiment.

In the second embodiment, step S112 is executed instead of step S12 in the first embodiment. In step S112, the processor 201 determines the extension period of the power control after the reservation slot based on a requested power value from the power grid PG. Specifically, when the power grid PG needs a predetermined amount (e.g., 20 KW) of electric power after the reservation slot, the processor 201 determines the extension period based on information on the predetermined amount. For example, the processor 201 may determine the extension period by dividing the predetermined amount by the discharging rate (rate of decrease in the SOC) of the EVSE unit 20.

The other configurations are the same as those of the first embodiment, and therefore description thereof will not be repeated.

### Third Embodiment

Next, a third embodiment of the present disclosure will be described. In the third embodiment, the extension period is determined based on an SOC change history of the electrified vehicle 10 unlike the first embodiment in which the extension period is determined based on the lower limit value specified by the user. The same components as those in the first embodiment are denoted by the same signs as those in the first embodiment, and description thereof will not be repeated.

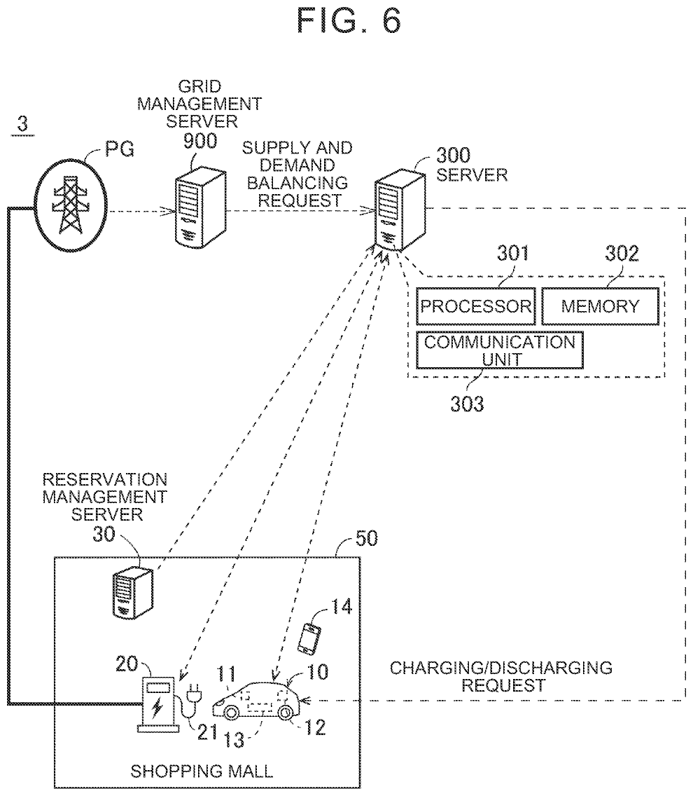

FIG. 6 shows the configuration of a system 3 according to the third embodiment. The system 3 includes a server 300 instead of the server 100 of the system 1 of the first embodiment.

The server 300 includes a processor 301, a memory 302, and a communication unit 303.

### Management Method

Next, a method for managing the power control by the system 3 will be described with reference to a sequence diagram of FIG. 7. Steps of the same processes as those of the first embodiment are denoted by the same signs, and description thereof will not be repeated.

As shown in FIG. 7, the process of step S4 in the first embodiment is not executed in the third embodiment.

In the third embodiment, the server 300 (processor 301) executes a process of step S211 before the process of step S6. In step S211, the processor 301 acquires information on an SOC change history that is based on the past travel history of the electrified vehicle 10. The processor 301 acquires the information on the change history from a server (not shown) that manages the SOC of the battery 13 or from the electrified vehicle 10 via the communication unit 303. The information on the change history may be stored in the memory 302 of the server 300.

In step S212 before the end of the charging control in the reservation slot, the processor 301 determines the extension period of the power control after the reservation slot based on the information on the SOC change history acquired in step S211. Specifically, the processor 301 estimates a permissible value of the SOC change amount by the VPP discharging after the reservation slot based on the change history. Specifically, the processor 301 estimates, based on the change history, an SOC value (permissible value) that does not hinder the travel of the electrified vehicle 10 after the extension period. For example, the permissible value may be a value that is larger by a predetermined amount (e.g., 20%) than an average value of the amount of decrease in the SOC during a time frame after the extension period. Thus, it is possible to reduce the occurrence of a case where the SOC falls below the predetermined amount after the extension period. The processor 301 determines the extension period so that the SOC does not fall below the permissible value.

The other configurations are the same as those of the first embodiment, and therefore description thereof will not be repeated.

The first to third embodiments illustrate the example in which the control is executed to check with the user during the charging control (power control) on the battery 13 whether the VPP discharging (power control) responding to the power supply and demand balancing request can be executed after the reservation slot. However, the present disclosure is not limited to this. The check may be executed at (immediately after) the end of the charging control (power control) on the battery 13. In the present disclosure, the phrase “immediately after the end of the power control on the battery 13” may mean, for example, a period from the end of the power control on the battery 13 to the leaving of the electrified vehicle 10 from the EVSE unit 20.

The first to third embodiments illustrate the example in which the battery 13 is charged in the reservation slot, but the present disclosure is not limited to this. The battery 13 may be discharged (e.g., in response to a VPP or energy management request) in the reservation slot.

The first to third embodiments illustrate the example in which the battery 13 is discharged in the extension period after the reservation slot, but the present disclosure is not limited to this. The battery 13 may be charged (VPP charging) in the extension period. Both charging and discharging may be executed.

The first to third embodiments illustrate the example in which the control is executed in response to the VPP request in the extension period after the reservation slot, but the present disclosure is not limited to this. Energy management that is control on the power supply and demand status of a predetermined facility (e.g., a commercial facility or a factory in a microgrid) may be executed in the extension period. In this case, the predetermined facility is an example of the “predetermined power system” according to the present disclosure.

The first to third embodiments illustrate the example in which the length of the extension period after the reservation slot is adjusted based on the predetermined information on electric power to be exchanged between the electrified vehicle 10 and the power grid PG (predetermined power system). However, the present disclosure is not limited to this. The length of the extension period may be constant regardless of the predetermined information.

The first to third embodiments illustrate the example in which the EVSE unit 20 is provided in the shopping mall 50, but the present disclosure is not limited to this. The EVSE unit 20 may be provided in a commercial facility other than the shopping mall 50 (e.g., an amusement park or a restaurant). The EVSE unit 20 may be provided in, for example, a parking lot instead of the commercial facility.

The first to third embodiments illustrate the example in which the user is notified that the extension period will be provided when confirmation is made that the VPP discharging (power control) can be executed after the reservation slot. However, the present disclosure is not limited to this. The user need not be notified that the extension period will be provided.

The first to third embodiments illustrate the example in which the server 100 (200, 300) and the reservation management server 30 are separate from each other, but the present disclosure is not limited to this. The server 100 (200, 300) may manage reservations for the power control.

The first to third embodiments illustrate the example in which the server 100 (200, 300) sets the extension period for the VPP discharging to be executed after the reservation slot, but the present disclosure is not limited to this. The extension period may be set (reserved) by the user of the electrified vehicle 10.

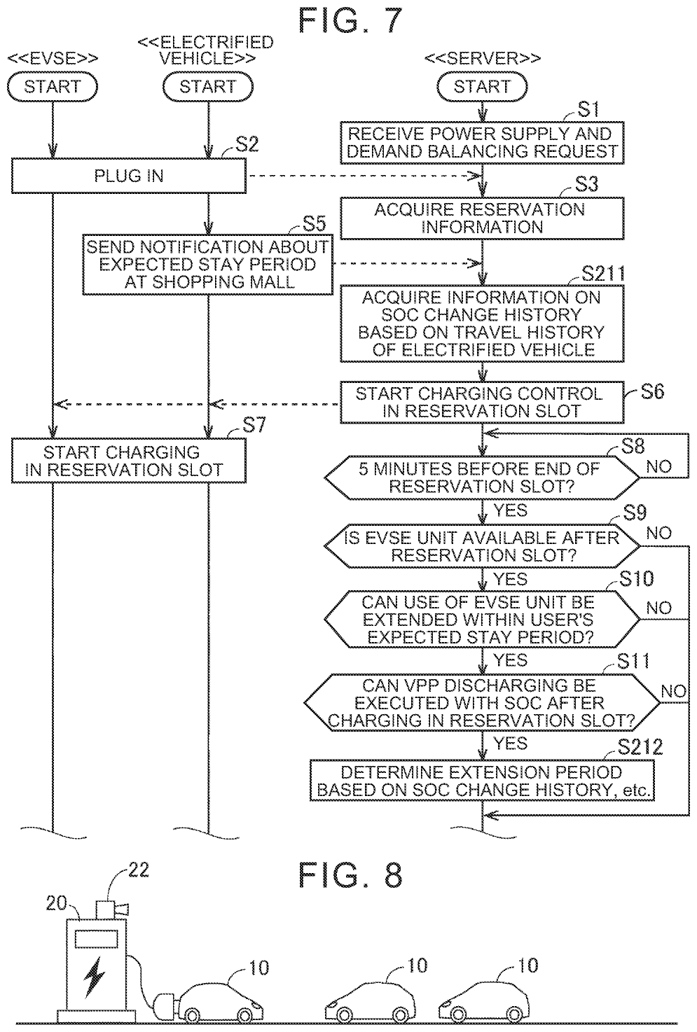

The first to third embodiments illustrate the example in which determination is made as to whether the EVSE unit 20 is available after the reservation slot based on the schedule managed by the reservation management server 30. However, the present disclosure is not limited to this. Determination may be made as to whether the EVSE unit 20 is available after the reservation slot based on an image captured by a camera 22 (see FIG. 8) installed on the EVSE unit 20. For example, determination may be made that the EVSE unit 20 is available after the reservation slot when the image captured by the camera 22 shows no electrified vehicle in a queue for the EVSE unit 20. The camera 22 may be installed near the EVSE unit 20.

The first to third embodiments illustrate the example in which the VPP control is started after an elapse of a period corresponding to the reservation slot, but the present disclosure is not limited to this. The VPP control may be started during the reservation slot.

The first embodiment illustrates the example in which the server 100 determines the extension period based on the period required for the SOC after the charging in the reservation slot to decrease to the lower limit value. However, the present disclosure is not limited to this. For example, the server 100 may reduce the SOC to a value lower than the lower limit value and then increase the SOC to the lower limit value. In this case, the extension period is determined based on a period required for the reduction in the SOC and a period required for the increase in the SOC.

The embodiments disclosed herein should be considered to be illustrative in all respects and not restrictive. The scope of the present disclosure is shown by the claims rather than by the above description of the embodiments, and is intended to include all modifications within the meaning and scope equivalent to the claims.

What is claimed is:

1. A server configured to manage power control between a power controller and an electrified vehicle, the power control including at least one of charging and discharging, the server comprising:
a communication unit configured to acquire information on a power supply and demand balancing request for balancing a power supply and demand status in a predetermined power system; and
one or more processors configured to control the power control in a reservation slot in which a reservation is made for the power control by a user of the electrified vehicle, wherein
the one or more processors are configured to execute control to check, with the user during a period from a start of the power control in the reservation slot to a time immediately after an end of the power control, whether the power control responding to the power supply and demand balancing request is executable after the reservation slot.

2. The server according to claim 1, wherein the one or more processors are configured to adjust a length of an execution period of the power control to be executed after the reservation slot based on predetermined information on electric power to be exchanged between the predetermined power system and the electrified vehicle by the power control after the reservation slot.

3. The server according to claim 2, wherein the predetermined information includes information on an upper limit value or a lower limit value specified by the user about a charge ratio of the electrified vehicle.

4. The server according to claim 2, wherein the predetermined information includes information on the power supply and demand status in the predetermined power system after the reservation slot.

5. The server according to claim 2, wherein the predetermined information includes information on a permissible value of an amount of change in a charge ratio of the electrified vehicle by the power control after the reservation slot, the permissible value being estimated by the one or more processors based on a change history of the charge ratio.

6. The server according to claim 1, wherein the one or more processors are configured to check availability of the power controller after the reservation slot before checking with the user whether the power control is executable after the reservation slot.

7. The server according to claim 1, wherein the one or more processors are configured to determine whether to check with the user whether the power control is executable after the reservation slot based on a charge ratio of the electrified vehicle after the power control in the reservation slot.

8. The server according to claim 1, wherein:
the communication unit is configured to acquire user stay information as to whether the user is expected to stay after the reservation slot at a predetermined commercial facility including the power controller; and
the one or more processors are configured to determine whether to check with the user whether the power control is executable after the reservation slot by using the user stay information acquired by the communication unit.

9. The server according to claim 1, wherein the communication unit is configured to acquire information on the power supply and demand balancing request in a power grid included in the predetermined power system.

10. The server according to claim 1, wherein the one or more processors are configured to execute control to notify the user that an execution period of the power control is to be extended when confirmation is made that the power control is executable after the reservation slot.

11. The server according to claim 1, wherein the one or more processors are configured to cause the electrified vehicle to execute the power control responding to the power supply and demand balancing request after the reservation slot when confirmation is made that the power control is executable after the reservation slot.

12. A system comprising:
a power controller configured to execute power control including at least one of charging and discharging;
an electrified vehicle; and
a server configured to manage the power control between the power controller and the electrified vehicle, wherein
the server is configured to acquire information on a power supply and demand balancing request for balancing a power supply and demand status in a predetermined power system,
the server is configured to control the power control in a reservation slot in which a reservation is made for the power control by a user of the electrified vehicle, and
the server is configured to execute control to check, with the user during a period from a start of the power control in the reservation slot to a time immediately after an end of the power control, whether the power control responding to the power supply and demand balancing request is executable after the reservation slot.

13. A management method for managing power control between a power controller and an electrified vehicle, the power control including at least one of charging and discharging, the management method comprising:
acquiring information on a power supply and demand balancing request for balancing a power supply and demand status in a predetermined power system;
controlling the power control in a reservation slot in which a reservation is made for the power control by a user of the electrified vehicle; and
checking, with the user during a period from a start of the power control in the reservation slot to a time immediately after an end of the power control, whether the power control responding to the power supply and demand balancing request is executable after the reservation slot.
